(19) United States
(12) Patent Application Publication
(10) Pub. No.: US 2006/0008661 A1
(43) Pub. Date: Jan. 12, 2006

(54) Manufacturable low-temperature silicon carbide deposition technology

(76) Inventors: Muthu B.J. Wijesundara, Albany, CA (US); Gianluca Valente, Milan (IT); Roger T. Howe, Martinez, CA (US); Albert P. Pisano, Danville, CA (US); Carlo Carraro, Orinda, CA (US); Roya Maboudian, Orinda, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/903,864

(22) Filed: Jul. 29, 2004

Related U.S. Application Data
(60) Provisional application No. 60/491,884, filed on Aug. 1, 2003.

(51) Int. Cl. B32B 13/04

(52) U.S. Cl. 428/446

(57) ABSTRACT

A method of depositing silicon carbide on a substrate, including placing a substrate in a low pressure chemical vapor deposition chamber; flowing a single source precursor gas containing silicon and carbon into the chamber; maintaining the chamber at a pressure not less than approximately 5 mTorr; and maintaining the substrate temperature less than approximately 900° C. The Method also includes a method for depositing a nitrogen doped silicon carbide by the addition of nitrogen containing gas into the chamber along with flowing a single source precursor gas containing silicon and carbon into the chamber.

### CROSS-REFERENCES TO RELATED APPLICATIONS

The present application claims priority to U.S. Provisional Patent Application No. 60/491,884, filed Aug. 1, 2003, the teachings of which are incorporated herein by reference for all purposes.

### STATEMENT AS TO RIGHTS TO INVENTIONS MADE UNDER FEDERALLY SPONSORED RESEARCH OR DEVELOPMENT

A part of this invention was made with Government support under Grant (Contract) Nos. N660010118967 and NBCHCO10060 awarded by DARPA, and Grant (Contract) No. 9782 awarded by the Department of Energy. The Government has certain rights to this invention.

### BACKGROUND OF THE INVENTION

The present invention relates to semiconductor processing methods, and in particular to a method of depositing silicon carbide (“SiC”) films on a variety of substrates including silicon, silicon carbide, quartz and sapphire substrates from a single precursor molecule utilizing a conventional low pressure chemical vapor deposition system.

The wide energy band gap, high thermal conductivity, large breakdown field, and high saturation velocity of silicon carbide makes this material an ideal choice for high temperature, high power, and high voltage electronic devices. In addition, its chemical inertness, high melting point, extreme hardness, and high wear resistance make it possible to fabricate sensors and actuators capable of performing in harsh environments, which has motivated the increasing interest in SiC in microelectromechanical systems (MEMS) technology. Furthermore, SiC is an attractive material for micro and nanomechanical resonators due to the large ratio of its Young's modulus to density, as compared to silicon.

The practical implementation of SiC for device fabrication requires high quality material processing with carefully defined and reproducible material properties. Furthermore, for the realization of SiC in MEMS technology, low temperature processing methods are preferred. Low growth temperatures are important to reduce the strain produced by the thermal expansion mismatch and to minimize the formation of crystal defects. In particular, in connection with MEMS devices, high residual stresses in SiC films deposited on Si substrates tend to result in deformed and nonviable microstructures after release.

Using chemical vapor deposition (CVD), poly- and single-crystalline SiC are typically grown at temperatures above 1100° C. using dual source precursors such as silane (SiH₄) and propane. In addition, a pre-carbonization step at 1200° C. is sometimes used for deposition on Si and SiO₂. Significant progress has been made in the growth of single crystalline SiC bulk films, with special emphasis on the 6H- and 4H-hexagonal polytypes, and the 3C-cubic polytype. More recent efforts have focused on the growth of cubic SiC thin films utilizing single precursors that contain both silicon and carbon atoms with reduced activation barrier for SiC formation. Several single-source precursor molecules have been successfully utilized to grow SiC at lower temperatures (e.g., 750-900° C.).

The inventors herein have utilized a 1,3-disilabutane, SiH₃—CH₂—SiH₂—CH₃, (“1,3-DSB”) precursor to deposit polycrystalline SiC thin films for MEMS applications at even lower deposition temperatures (e.g., approximately 650-900° C.). This precursor is a liquid at room temperature, and is rather benign. These characteristics make the handling aspects much simplified when compared to conventional dual-source CVD utilizing such gases as SiH₄. Furthermore, when using this precursor no pre-carbonization step is used for deposition on Si and SiO₂. However, the SiC deposition using 1,3-DSB has been limited to high vacuum (˜10⁻⁶ Torr) and custom-built systems capable of processing samples less than 1×1 cm² in size. For this deposition methodology to find widespread use, it needs to be realizable in a conventional chemical vapor deposition system for this process.

### BRIEF SUMMARY OF THE INVENTION

The present invention is directed to the deposition of 3C—SiC films on a variety of substrates from a 1,3-disilabutane precursor molecule utilizing a conventional low pressure chemical vapor deposition system. The chemical, structural, and growth properties of the resulting films were investigated as functions of deposition temperature and flow rates. Based on X-ray photoelectron spectroscopy, the films deposited at temperatures as low as 650° C. were indeed carbidic. X-ray diffraction analysis indicated the films were amorphous up to 750° C., above which they become polycrystalline. Highly uniform films were achieved at 800° C. and lower, essentially independent of the flow rate of precursor gas.

In certain aspects, the present invention is directed to adjusting the electrical resistivity of the SiC films deposited in accordance with the embodiments of the present invention by introducing ammonia to induce a nitrogen doping in the resulting film. The nitrogen is successfully incorporated throughout the SiC film. The doped films exhibit lower resistivities than the undoped films deposited at the same temperature, except for the films deposited at 650° C. As the deposition temperature increases, the electrical resistivity is shown to increase and then decrease, peaking at 750° C. The resistivity of the polycrystalline SiC films is further controlled by adjusting the NH₃ flow rate in the reactor. The lowest resistivity of 0.02 Ωcm was achieved for the film deposited at 800° C. and the NH₃ flow rate of 5 standard cubic centimeters per minute (sccm). Post deposition annealing was used to lower the film resistivity to 0.01 Ωcm. This is the lowest resistivity value reported for SiC deposition, in particular at the low deposition temperature of approximately 800° C.

For a further understanding of the nature and advantages of the invention, reference should be made to the following description taken in conjunction with the accompanying drawings.

### BRIEF DESCRIPTION OF THE DRAWINGS

FIG. 1 is a schematic diagram of an exemplary tubular CVD reactor used for SiC deposition using 1,3-disilabutane, in accordance with embodiments of the present invention.

FIG. 2 is a graph showing C(1s) and Si(2p) core level X-ray photoelectron spectra of 3C—SiC thin films grown using 1,3-disilabutane at approximately 800° C.

FIG. 3 is a graph showing elemental composition of cubic-SiC thin films grown from 1,3-disilabutane in the temperature range of approximately 650 to approximately 850° C.

FIGS. 4a-c are graphs showing X-ray diffraction spectra of 3C—SiC films on Si(100) substrate grown from 1,3-disilabutane at (a) approximately 700° C., (b) approximately 750° C., and (c) approximately 800° C., for SiC film having a thicknesses of approximately 2 μm.

FIGS. 5a-b show AFM images of 3C—SiC films on Si(100) substrate grown using 1,3 disilabutane at (a) approximately 700° C. and (b) approximately 800° C., for a 10 μm×10 μm area and z height of 200 nm.

FIG. 6 is a graph showing SiC growth rate as a function of the sample length along the reactor axis, where Position 0 corresponds to the center of the reactor tube.

FIG. 7 is a graph showing SiC growth rates at the up and down stream ends of the sample for flow rates of 5.5 sccm (a) and 6.5 sccm (b).

FIG. 8 shows the cross-sectional SEM image of microtrenches coated with 2 μm 3C—SiC films grown using 1,3-disilabutane at approximately 800° C.

FIGS. 9a-c are graphs showing the high resolution N (is) photoemission peaks of SiC films deposited at approximately 650° C. with NH₃ flow rate of 2 sccm (a), approximately 800° C. with NH₃ flow rate of 2 sccm (b), and approximately 800° C. with NH₃ flow rate of 4 sccm (c).

FIGS. 10a-c are graphs showing X-ray diffraction spectra of doped and undoped 3C—SiC films on Si(100) substrates grown from 1,3 disilabutane (5 sccm). Doping is achieved by introducing NH₃ at a flow rate of approximately 2 sccm (5% NH₃ in H₂) during the deposition (a) undoped (bottom) and doped (top) at approximately 700° C., (b) undoped (bottom) and doped (top) at approximately 750° C., and (c) undoped (bottom) and doped (top) at 800° C. SiC film thicknesses are approximately 1 μm for all samples.

FIG. 11 is a graph showing the resistivity of the doped 3C—SiC films, deposited from 1,3 disilabutane and NH₃ with the flow rates of approximately 5 and 2 sccm, respectively, as a function of deposition temperature.

FIG. 12 is a graph showing the resistivity of the 3C—SiC films deposited at approximately 800° C. as a function of NH₃ flow rate.

FIGS. 13a-b are graphs showing the high-resolution N (Is) photoemission spectra of SiC films deposited at approximately 800° C. with NH₃ flow rate of about 2 sccm before (a) and after annealing (b) to approximately 1000° C. for 8 hours.

FIG. 14 is a graph showing the resistivity of doped SiC films grown approximately 800° C. with NH₃ flow rate of about 2 sccm vs. the annealing temperature.

### DETAILED DESCRIPTION OF THE INVENTION

Embodiments of the present invention are directed towards the deposition of SiC films utilizing a single precursor, namely, a 1,3-disilabutane, SiH₃—CH₂—SiH₂—CH₃, (1,3-DSB) precursor to deposit polycrystalline SiC thin films at lowered deposition temperatures (e.g. lower than approximately 900° C.). The description below provides the processing parameters in a commercial low pressure CVD (LPCVD) reactor for the deposition of SiC films on Si(100) and other wafers from 1,3-DSB.

The chemical, structural, electrical, and growth properties of the resulting films were investigated as functions of deposition temperature and flow rates. Based on X-ray photoelectron spectroscopy (“XPS”), the films deposited at temperatures as low as approximately 650° C. are indeed carbidic. X-ray diffraction (“XRD”) analysis indicates the films to be amorphous up to approximately 750° C., above which they become polycrystalline. Highly uniform films are achieved at approximately 800° C. and lower, essentially independent of the flow rate.

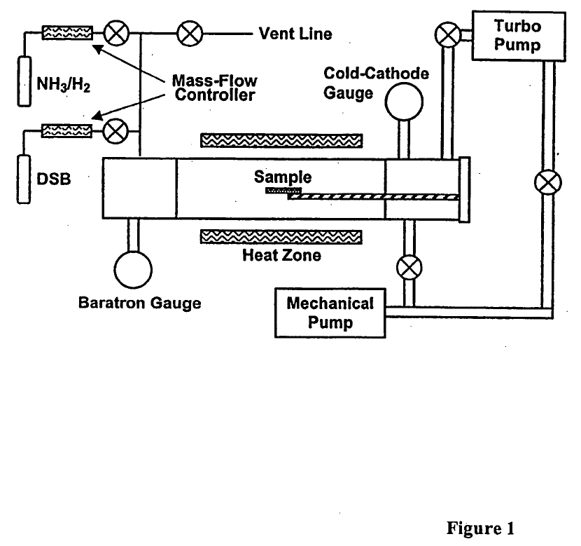

FIG. 1 shows the schematic diagram of a conventional horizontal hot-wall tubular reactor (e.g., TekVac CVD-300-M) that is one example of a LPCVD reactor that may be configured to practice the embodiments of the present invention. Briefly, the reactor consists of a quartz tube (75 mm inner diameter, 600 mm long) with a hot-wall zone of 450 mm in length with temperature uniformity of ±1° C. The reactor base pressure is less than 10⁻⁷ Torr using an 80 l/s turbo molecular pump. The precursor molecule, 1,3-DSB (Gelest Inc., >95% purity) is further purified by freeze-pump-thaw cycles using liquid N₂ before introduction into the reactor via a mass flow controller (e.g., MKS SDS-1640).

All examples described herein were performed on 30 mm×80 mm rectangular samples of Si(100) substrate. Prior to deposition, n-type Si(100) substrate was dipped in concentrated hydrofluoric acid (“HF”) to remove the native oxide, then rinsed with deionized water and dried under nitrogen (N₂). The substrate was placed horizontally, parallel to the gas flow in the center of the hot-wall zone of the reactor tube as shown in FIG. 1. Most of the examples described here, unless described otherwise, were carried out at a 1,3-DSB flow of 5.5 sccm with the reactor pressure of approximately 50 mTorr. The substrate temperature was varied from approximately 650° C. to approximately 850° C. to investigate the effect of temperature on the deposition process. Due to the changes in growth rate with the temperature, the deposition times were varied (e.g., 1 to 4 hours) in order to achieve films with nearly the same thickness of 2 μm.

Various analysis and characterization techniques were employed to investigate the effect of deposition temperature on the film composition, structure, and growth rate and uniformity. Ex situ XPS was used to determine the chemical nature and elemental composition of the deposited films. The XPS analysis was performed using an Omicron Dar400 achromatic Mg—K X-ray source (15 keV, 20 mA emission current) and an Omicron EA 125 hemispherical analyzer. The analyzer was operated in the constant energy mode with 50 eV pass energy. The elemental percentages of the films were determined based on the high-resolution photoemission peak areas, photoionization cross-sections and the electron energy analyzer transmission function. XRD patterns were recorded using a Siemens D5000 automated diffractometer operated in θ-2θ geometry to determine the crystal structure of the deposited SiC films. The film morphology was examined by a Digital Instrument Nano Scope III atomic force microscope (“AFM”) in contact mode. Both optical reflectometry (NanoSpec Model 3000 ) and cross-sectional scanning electron microscope (JEOL 6400 SEM) were employed to determine the film thickness. SiC film thicknesses estimated by cross-sectional SEM were found to be in good agreement with the values obtained by optical reflectometry. In addition, the electrical resistivity of the films was evaluated using a Signatone S-301 four-point probe and the film's chemical resistance was evaluated by wet chemical etching in hot (65° C.) 30% wt. potassium hydroxide (“KOH”) solution.

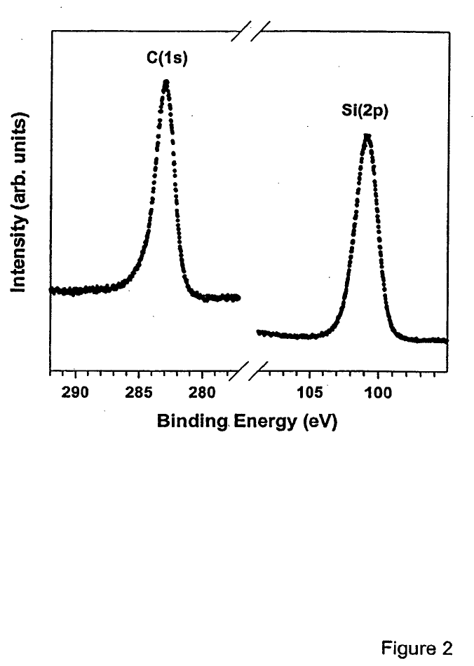

XPS spectra were recorded to investigate the chemical composition of the SiC films deposited at different temperatures. For the peak assignment, all core level photoemission peaks are referenced to the C(1s) peak at 285.0 eV binding energy, present due to adventitious hydrocarbon contaminants resulting from the ex situ handling. Survey scans showed photoemission peaks for silicon (“Si”), carbon (“C”), and oxygen (“O”) in all films. However, intensity of the 0 (1s) photoemission peak decreases dramatically to less than 2% with a brief sputtering with Argon ions (“Ar+”) at 1.5 keV confirming that the oxygen is mostly located in the near surface region and not in the bulk. The high resolution Si(2p) and C(1s) photoemission spectra of SiC films deposited at approximately 800° C. are shown in FIG. 2. The relative peak positions for the Si(2p) and C(1s) are approximately 100.5 eV and approximately 283.3 eV, respectively, and are consistent with earlier data reported on silicon carbide. The peak positions and the shapes remain unchanged as the deposition temperature is varied from approximately 650° C. to approximately 850° C., indicating that the deposited films remain SiC over this temperature range.

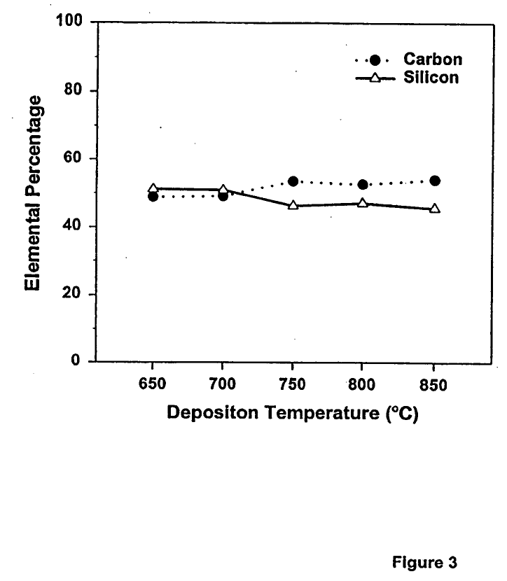

High-resolution photoemission spectra of Si (2s), C(1s) and O(1s) were used in the calculation of the elemental composition. In FIG. 3, Si and C elemental percentages are displayed as a function of the deposition temperature after normalization by the small extraneous oxygen component. FIG. 3 shows that the Si/C ratio is nearly 1:1 with slight carbon enrichment at the surface for temperatures above 750° C. As described below, the crystal structure of the films also changes from amorphous to crystalline for the deposition temperatures above 750° C.

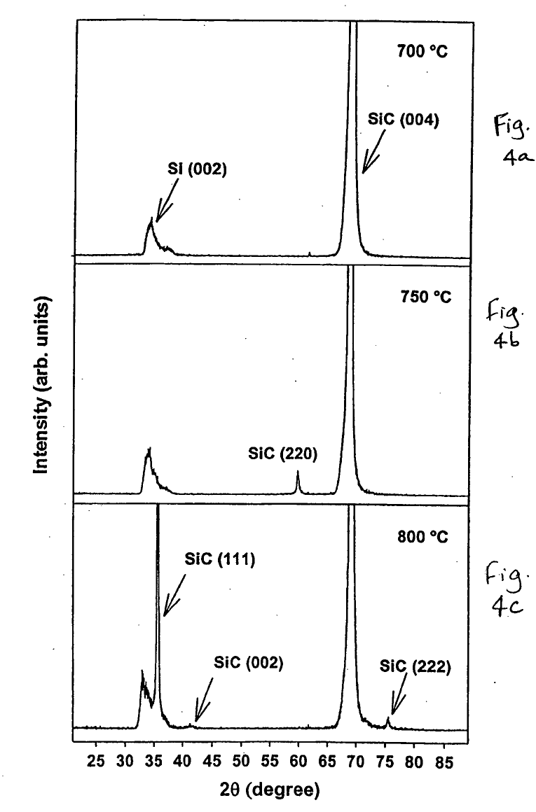

The XRD 0-20 spectra of SiC films grown at approximately 700° C., 750° C., and 800° C. are shown in FIG. 4. The XRD spectrum of SiC film deposited at 700° C. (FIG. 4a) exhibits diffraction patterns associated with Si (002) and (004) planes characteristics of the underlying Si substrate with no significant signals due to SiC. A similar spectrum (data not shown) is observed for the film deposited at 650° C. FIG. 4b indicates a 3C—SiC (220) crystal plane for the film deposited at 750° C. At 800° C. deposition temperature, the SiC film shows a strong 3C—SiC(111) crystal plane, a less pronounced 3C—SiC (222) crystal plane, and a minor signature of 3C—SiC (002) crystal plane, as shown in FIG. 4c. Similar XRD patterns are obtained for the films deposited at 850° C. These results indicate that the SiC crystal structure changes from amorphous to polycrystalline when the deposition temperature changes from approximately 650° C. to 850° C. with transition occurring around about 750° C.

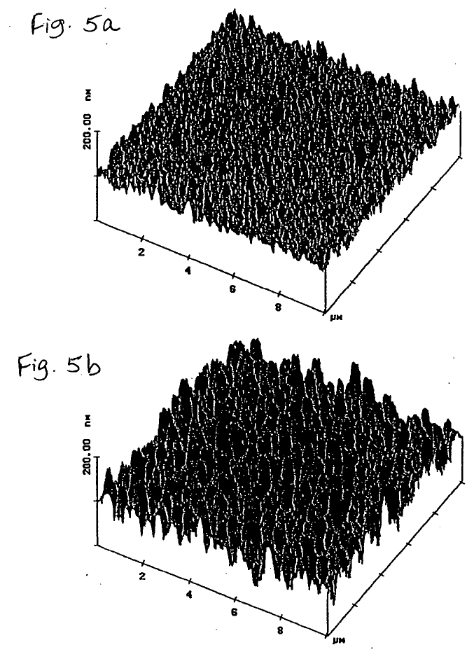

FIG. 5 displays AFM images over a 10 μm×10 μm area of SiC films grown at approximately 700° C. (a) and 800° C. (b). Both films have the same thickness (˜2 μm) and are grown at 5.5 sccm flow rate and 50 mTorr pressure. The images suggest that the films exhibit a grain structure, which varies in size with temperature. In Table 1, the RMS roughness values obtained from the AFM images and the growth rates obtained for these samples are listed. In general, the surface roughness is found to increase with increase in deposition temperature, perhaps due to increase in growth rates.

TABLE 1
RMS roughness values and growth rates obtained from
AFM images over the 10 μm × 10 μm area.

| Temperature (° C.) | RMS roughness (nm) | Growth rate (nm/min) |
|---|---|---|
| 650 | 8.7 | 8 |
| 700 | 9.5 | 16 |
| 750 | 11.4 | 34 |
| 800 | 21.7 | 55 |
| 850 | 22.8 | 68 |

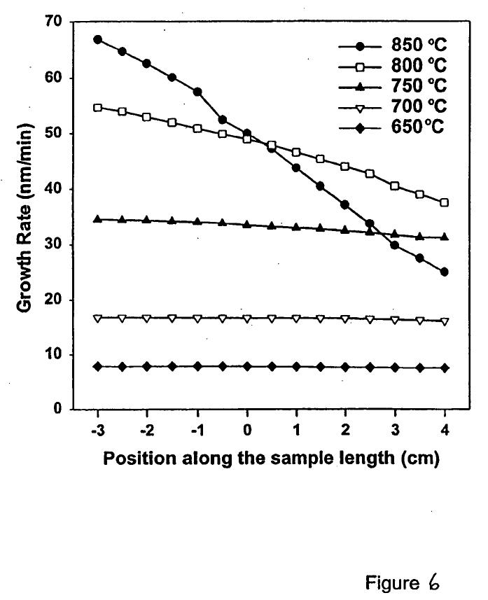

For fabrication purposes, the film growth rate and uniformity needs to be well characterized under a variety of processing conditions. The thickness of the SiC film was measured at 15 different spots separated by 0.5 mm along the sample length and was utilized to evaluate the growth rate. FIG. 6 illustrates growth rate at different temperatures measured as a function of distance along the length of the sample, from the up stream end. The zero point on the horizontal axis corresponds to the center of the hot zone. The data indicate that the growth rate increases with the deposition temperature. The growth rate is quite uniform along the sample length for deposition temperatures below 800° C., whereas it varies significantly for 800° C. and above.

The overall reaction, in accordance with the embodiments of the present invention, for producing SiC may be written as follows:
CH₃SiH₂CH₂SiH₃ (g)→2SiC (s)+5H₂ (g)

where one 1,3-DSB molecule produces five hydrogen molecules upon conversion to SiC. The conversion of DSB to SiC is a pyrolysis reaction, and therefore the surface reaction rate is higher at higher temperatures. The higher conversion rate of DSB causes depletion of the precursor, which consequently lowers the growth rate down stream. In addition, production of hydrogen dilutes the precursor and causes the growth rate to be reduced further down stream. Moreover, computational analysis described in a paper submitted to the Journal of Electrochemical Society indicates that gas-phase decomposition reactions play an important role in film growth and uniformity. At low temperatures (e.g., less than approximately 750° C.), the gas phase reaction is not dominant and the deposition is controlled by the surface reaction of 1,3-DSB with relatively low sticking coefficient. However at high temperatures, the gas phase reaction of 1,3-DSB produces species with high sticking probabilities. The different depletion of these reactive species leads to the particularly sharp profiles observed in FIG. 6. As a consequence, the higher the temperature, the larger the growth rate variation along the sample length. In relation to the example results summarized in FIG. 6, the substrate was placed horizontally in the hot zone with the flow of gas being parallel to the surface of the substrate. The inventors herein have determined that the uniformity of the growth rate is enhanced when the substrates are placed vertically in the hot zone, such that the gas flow is generally perpendicular to the substrate's surface.

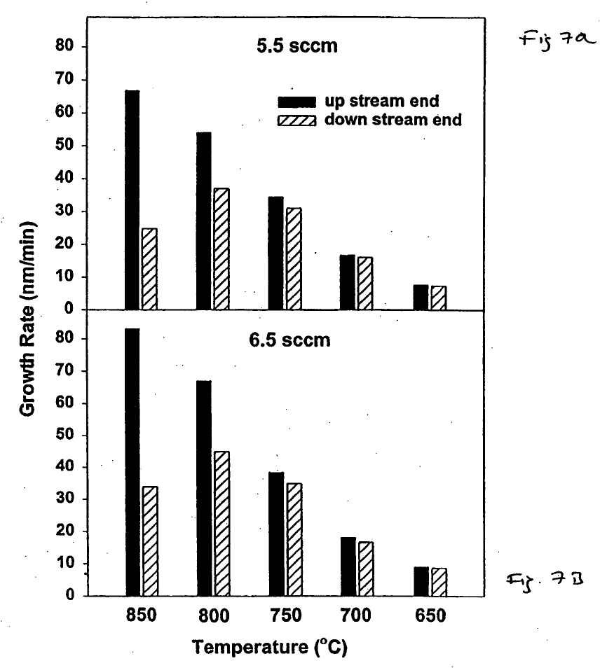

In order to understand qualitatively the effect of the depletion on growth rate, the flow rate of the precursor was increased from 5.5 to 6.5 sccm while maintaining all other process conditions the same. The bar graph in FIG. 7 illustrates the change in the film growth rate due to increased flow rate at the up stream and down stream ends of the reactor (position −3 and +4 in FIG. 6, respectively). Even though the growth rate increases, the growth profile is found to be unaffected by the increase in flow rate. At temperatures below approximately 750° C., the growth rate does not increase significantly, confirming that 1,3-DSB gas-phase decomposition does not take place to a significant degree and the growth proceeds slowly. Therefore, the precursor depletion is low and the deposition is surface reaction controlled. However, at temperatures above 750° C., the growth rate increases more significantly as the flow rate is increased. This observation further supports the proposition that the deposition process at high temperatures is predominantly controlled by the concentration of the precursor molecules in the gas phase.

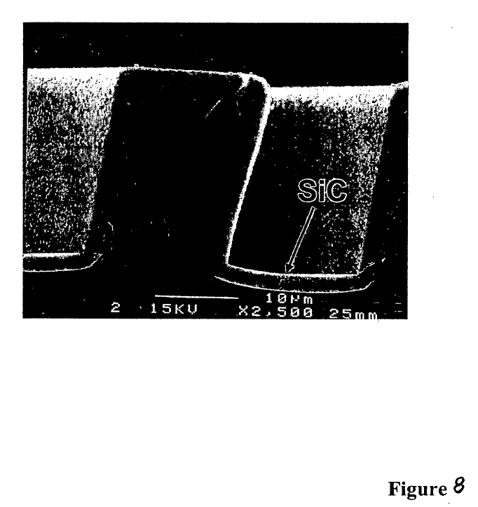

In order to investigate the sidewall coverage and the conformality of the deposited films, a Si substrate with microtrenches fabricated by deep reactive ion etching was placed in the reactor parallel to the gas flow. The trench is approximately 20 μm wide and 25 μm deep. FIG. 8 shows the cross-sectional SEM image of the microtrench coated with 2 μm thick SiC film deposited at approximately 800° C. The coating is found to be uniform and conformal with good detail transfer. Similar SEM images were observed for the trenches placed perpendicular to the gas flow. These results confirm the feasibility of this method for the coating of MEMS devices with a SiC coating. The SiC coating may be used as a wear resistance coating for MEMS structures and/or to cover SiC-coated MEMS structures.

Sheet resistivity values obtained by a four-point probe along with the film thickness measurements were used to calculate the resistivity of the SiC films. The resistivity of the films deposited at approximately 800° C. and 850° C. vary over the range of 10-100 Ωcm. The resistivity was found to be very large for the films deposited at 750° C. and below (e.g., outside the range accessible by the used four-point probe). The higher resistivity further confirms the amorphous nature of the films at lower deposition temperatures.

The chemical resistance of the films was investigated by dipping the samples in 33% wt KOH at 65° C. for about 60 minutes. Silicon carbide films show no film delamination or crack development indicating that the films are pinhole free. Under similar conditions, silicon (100) is etched at about 1 μm/min.

Using the single precursor and the LPVCD reactor operated as set forth above, demonstrates the feasibility of depositing 3C—SiC films using 1,3-DSB precursor in a commercial LPCVD reactor.

Certain aspects of the embodiments of the present invention are directed at adjusting the electrical resistivity of the SiC films deposited as set forth above. In particular, nitrogen doping is used to adjust the electrical resistivity of the SiC films. Nitrogen doping of poly-SiC films has been achieved by addition of ammonia (“NH₃”) to the 1,3-DSB precursor gas.

As described above, the growth of poly-SiC thin films utilizing 1,3-DSB precursor in a conventional low-pressure CVD reactor has been demonstrated. The deposited films were found to be polycrystalline at approximately 750° C. and above. Additionally, the inventors herein have shown that residual strain can be tuned for MEMS applications by the selection of deposition parameters, with a preferred set of mechanical properties obtained at approximately 800° C. In other words, the 800° C. films gave better mechanical properties as compared to the other deposition temperatures using the methodology described above.

The description set forth below is directed toward the in-situ nitrogen doping of SiC films in a commercial LPCVD reactor. In addition, the disclosure below describes the effects of deposition temperature, ammonia flow rate and post deposition annealing on the film's characteristics.

Using the reactor generally described above, the reactor's base pressure is maintained below 5×10⁻⁷ Torr using a 80 l/s turbo molecular pump. The precursor 1,3-DSB (Gelest Inc., >95% purity) is further purified by freeze-pump-thaw cycles using liquid N₂ before introduction into the reactor. Gaseous NH₃ (Matheson, 5% NH3 in H2) was intentionally added as a dopant precursor. Both NH₃ and 1,3-DSB were introduced to the reactor via mass flow controllers calibrated for NH₃ (MKS -8100) and 1,3-DSB (MKS SDS-1662). As used herein, the NH₃ flow rate, refers to a mixture of 5% NH₃ in a balance of H₂ carrier gas. The use of diluted NH₃ enhances the accuracy of the NH₃ delivery when using small increments in the flow controller.

SiC films were deposited on 30 mm×80 mm rectangular samples of n-type Si(100) substrates. Before introduction to the deposition chamber, the Si substrate was dipped in concentrated HF to remove the native oxide, then rinsed with deionized water and dried under N₂ flux. The substrate was mounted, parallel to the gas flow in the center of the hot zone of the reactor tube. The deposition temperature was varied from approximately 650 to approximately 850° C. to investigate the effect of temperature on the doping process. All the examples reported here were performed at a 1,3-DSB flow rate of approximately 5.0 sccm. The NH₃ flow rate is varied from nearly 0 to approximately 5 sccm (maximum flow rate available) in order to evaluate the effect of relative NH₃ concentration on doping. The reactor pressure during the deposition was determined by the deposition temperature and the total flow rate of 1,3-DSB and NH₃. The reactor pressure was high at high deposition temperatures due to enhanced thermal decomposition of 1,3-DSB and NH3. Typically, the reactor pressure varied from about 20 to about 50 mTorr. Due to the changes in growth rate with deposition temperature, the deposition time was varied (30 to 240 minutes) in order to achieve films with nearly the same thickness of 1 μm. In order to investigate the effect of post deposition annealing on dopant activation, some of the SiC samples were annealed in an argon ambient (1 atm) in a temperature range of 900-1200° C. for about 8 hours.

Various analysis and characterization techniques were employed to investigate the effect of nitrogen doping on the SiC film composition, structure, growth rate, and electrical conductivity. Ex situ XPS was employed to evaluate the elemental composition of the deposited films as well as the chemical state of the elements. The X-ray photoelectron spectrometer used was equipped with an Omicron Dar400 achromatic Mg—Kα X-ray source (15 keV, 20 mA emission current) and an Omicron EA 125 hemispherical analyzer. The analyzer was operated in constant energy analyzer mode with 50 eV pass energy. Peak areas of high-resolution photoelectron spectra were converted to elemental percentages using photoionization cross-sections and the electron energy analyzer transmission function. Prior to the introduction to the XPS chamber, SiC films are cleaned with 20% HF in water solution and 33% KOH in water solution at 65° C. to remove residual contaminants and oxide from the surface. The crystal structure of the deposited films was determined using a Siemens D5000 automated diffractometer operated in θ-2θ geometry. The film thickness was measured by optical reflectometry using a NanoSpec Model 3000 interferometer. Sheet resistivity was obtained using a Signatone S-301 four-point probe with in-line configuration.

Ex situ X-ray photoemission spectra were collected to investigate the chemical composition of the SiC films. All photoemission peaks are referenced to the C(1s) hydrocarbon (contaminant) peak at 285.0 eV binding energy. It should be realized that XPS probes about a few nanometers of the surface region and hence, the data reflect the near surface composition. The survey scans show photoemission peaks for Si, C, and O in all films (data not shown). The peak positions for the Si(2p) (101.0 eV) and C(1s) (283.5 eV) are consistent with the data reported in literature for SiC. Additionally, a peak for nitrogen (“N”) appears for all doped samples regardless of the deposition temperature and the NH₃ flow rate. High-resolution XP spectra were recorded for each element and used in the calculation of the elemental composition. Oxygen content is approximately 3% for all the samples, and is attributed mainly to surface contamination due to atmospheric gases before and during sample transfer to the XPS chamber. The nitrogen content of the films slightly increases as the NH₃ flow rate is increased from a minimum of slightly above 0 to approximately about 5 sccm. The Si/C ratio is observed not to significantly change.

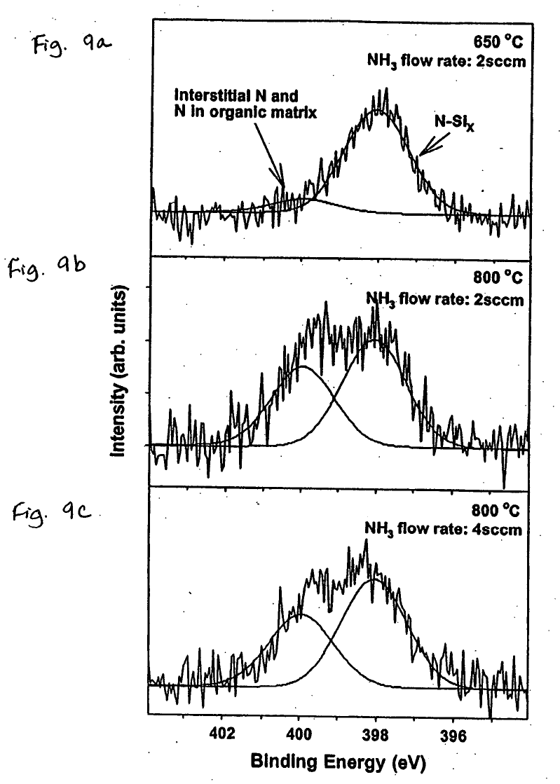

The high-resolution N(1s) core level spectra of SiC films grown under various conditions are shown in FIG. 9. The N spectra clearly indicate two overlapping peaks; the one centered at 398.0 eV binding energy is due to N-Si bonding while the other peak centered at 400.0 eV is due to N in both interstitial and organic matrix sites. The intensity ratios of these two peaks change with the deposition temperature, and to a lesser extent with the NH₃ flow rate, as seen in FIG. 9, with the N-Si bonding environment dominating for the films deposited at lower temperatures.

The growth rate was determined as a function of NH₃ flow rate at the 800° C. deposition temperature. The increase in NH₃ flow rate from 0 to 5 sccm does not significantly affect the SiC growth rate, with the rate remaining at about 33 nm/min. For the undoped samples, modeling indicates that the SiC growth rate was mainly determined by the adsorption rate of 1,3-DSB on the surface and the desorption rate of hydrogen from the surface. For the doping examples, NH₃ and H₂ are also present in the reactor. The adsorption rate of H₂ on SiC was found to be negligible. On the other hand, the ammonia adsorption changes the surface free sites. Therefore, it is speculated that in the examples, the NH₃ concentration in gas phase is substantially lower. As a consequence, the surface free site, and hence, the growth rate of SiC are affected to a lesser extent by the addition of NH₃.

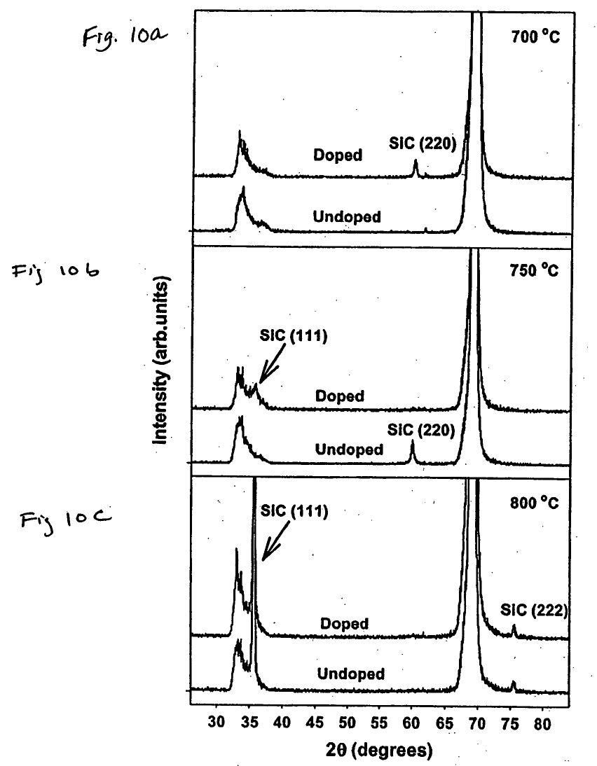

The XRD θ-2θ spectra were recorded for all films. FIG. 10 shows the XRD data for undoped and doped films with about a 2 sccm NH₃ flow rate deposited at the temperatures of approximately 700° C., approximately 750° C., and approximately 800° C. The XRD spectra of undoped films are consistent with the previously reported data. All spectra show Si (002) and (004) crystal planes at 33° and 70°, respectively, due to the underlying substrate. In FIG. 10a, the undoped SiC film deposited at 700° C. exhibits no diffraction patterns associated with SiC crystal planes indicating that the film is amorphous. The film crystallinity changes with the introduction of NH₃ to the reactor and shows a signature of (220) 3C—SiC crystal plane at 700° C. The film crystallinity is also observed to change for the films deposited at 750° C. As seen in FIG. 10b, the SiC film doped with about 2 sccm NH₃ flow rate exhibits a minor signature of (111) 3C—SiC crystal plane while undoped film displays a peak for (220) 3C—SiC plane. For the films deposited at approximately 800 and approximately 850° C., XRD spectra show (111) and (222) 3C—SiC crystal planes for both doped and undoped films.

XRD data of undoped films indicate that the SiC crystal structure changes from amorphous (approximately up to 700° C.) to partly crystalline with (220) plane (at approximately 750° C.) to polycrystalline with mainly (111) plane (approximately 800° C. and above) as the deposition temperature increases from 650 to 800° C. With the introduction of NH₃ to the reactor, the transition from amorphous to polycrystalline appears to shift to lower temperatures with respect to undoped films. For instance, films are amorphous at 650° C. and transition to crystallinity appears at 700° C., 50 degrees lower than for the undoped films. This doping induced crystallization in SiC has not been observed before. While not being limited to any particular theory, it may be that the changes in the electronic structure of the surface and the surface diffusion coefficient due to nitrogen incorporation may be responsible for inducing crystallization at lower temperatures.

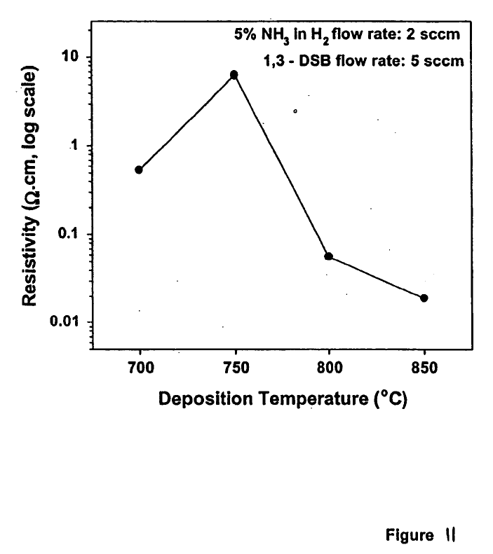

Sheet resistivity values obtained by four-point probe along with the film thickness measurements were used to determine the effect of nitrogen incorporation on the film resistivity. For the electrical characterization, the SiC films were grown on SiO₂ in order to avoid substrate effects. The XPS and XRD investigations confirmed that the film composition and the crystal structure are not affected by the changes in the substrate from Si(100) to SiO₂ within the temperature range between 650 and 850° C. The resistivity measurements were carried out on films with different thicknesses (>1 μm) deposited under the same conditions to evaluate the thickness effect on resistivity. For this range of thickness, the resistivity values were found not to be affected by the film thickness. The resistivity of undoped films deposited in the LPCVD reactor is approximately 130, 10, and 5 Ω·cm for the film deposited at approximately 750° C., approximately 800° C., and approximately 850° C., respectively. Films deposited at approximately 650° C. and approximately 700° C. are nonconductive (resistivity values outside the measurement range of 500 Ωcm) and amorphous. The resistivities of the SiC films deposited at various temperatures with about 5 sccm 1,3 DSB flow rate and 2 sccm NH3 flow rate are shown in FIG. 11. The film deposited at approximately 750 ° C. shows higher resistivity than the film deposited at about 700 ° C. This might be due to the crystalline quality changes as evident by the XRD data. Namely, at 700 ° C., the film shows (220) crystalline phase whereas, at 750° C., the (220) crystal phase diminishes and 3C—SiC (111) phase starts growing. Above 750° C., the resistivity decreases as the deposition temperature increases.

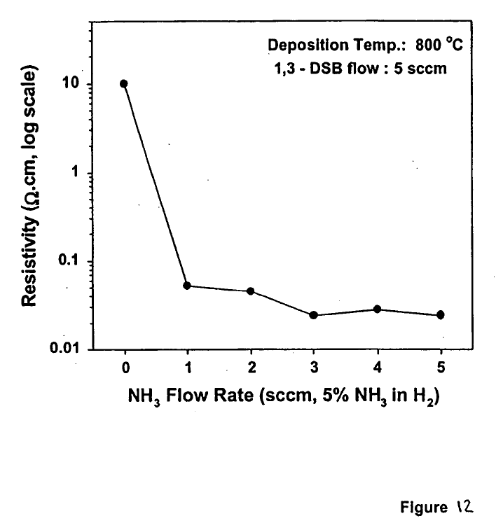

FIG. 12 displays the effect of NH₃ flow rate on the resistivity of the SiC films deposited at approximately 800° C. It indicates that the resistivity decreases as NH₃ flow rate increases within the reported range and the lowest resistivity of 0.02 Ωcm is achieved with NH₃ flow rate of about 5 sccm. The XRD data confirms that the crystalline quality remains unchanged as the NH₃ flow rate varies from nearly 0 to about 5 sccm. It is noted that excessive NH₃ in the reactor may lead to preferential formation of Si₃N₄ within the SiC film, which may substantially affect the crystalline structure and the conductivity of the SiC film.

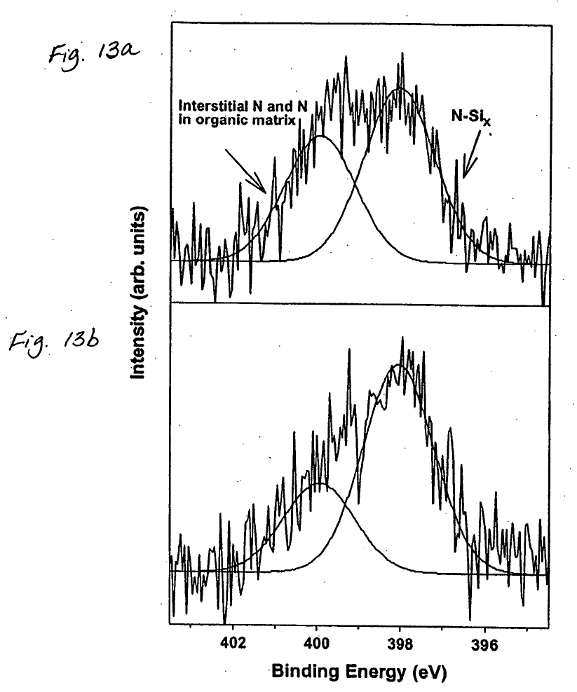

In order to investigate the effect of post deposition annealing on dopant activation, the films were annealed subsequent to their deposition, and analyzed. FIG. 13 displays the N(1s) high resolution XP spectra of doped SiC films grown with the NH₃ flow rate of about 2 sccm, before (a) and after (b) annealing for 8 hours at approximately 1000° C. The Spectra exhibit a decrease in the peak centered at 400 eV, indicating a decrease of nitrogen (“N”) in organic matrix and interstitial sites. This observation can be explained by two possible phenomena. The N in organic matrix and interstitial sites may convert into N bound to silicon (“Si”) with the heat treatment. In addition, some nitrogen may desorb through grain boundaries at higher temperatures, even though the diffusion in SiC is known to be very slow.

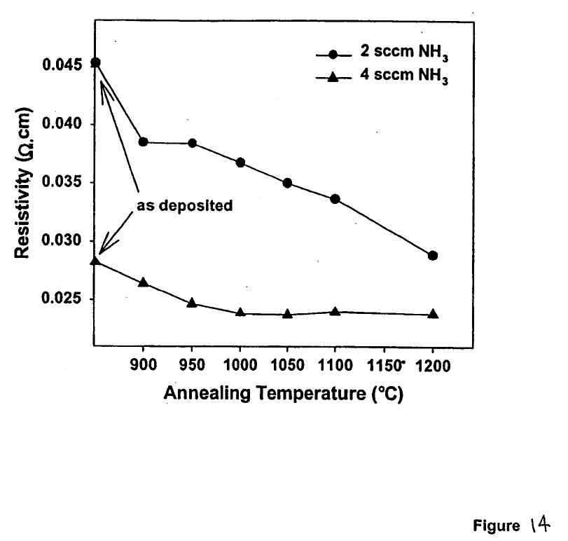

FIG. 14 presents the resistivity of the SiC films doped with NH₃ flow rate of 2 and 4 sccm vs. the annealing temperature. In general, resistivity decreases as the annealing temperature increases. This might be due to formation of new N—Si bonds as evident from XPS. Moreover, it may be that annealing leads to changes in grain boundaries and crystal defects, as has been observed in SiGe, resulting in a decrease in resistivity. More specifically, the resistivity of the SiC doped using NH₃ flow rate of 2 sccm continues to decrease within the temperature range covered by the examples. In contrast, the resistivity of the films doped using NH₃ flow rate of 4 sccm decreases until about 1000° C. annealing temperature and stays relatively unchanged for higher temperatures. This behavior may suggest that the maximum intake of N in the lattice is achieved under the conditions.

The examples set forth above address the chemical, structural, and electrical characteristics of in situ nitrogen doped 3C—SiC films grown in a conventional LPCVD reactor from 1,3-disilabutane and NH₃ at various growth temperatures. The nitrogen was observed for all doped SiC films within the entire temperature range examined. Both undoped and doped films deposited at about 650° C. are nonconductive and amorphous. All the other doped samples have lower resistivity than the undoped samples, for films deposited at the same temperature. However, as the temperature is increased from about 700° C. to about 850° C., the electrical resistivity is shown to increase and then decrease, peaking at 750° C. The resistivity data for the film deposited at about 800° C. confirms that controlled doping of 3C—SiC can be achieved by controlling the NH₃ flow rate in the reactor. The lowest resistivity of 0.02 Ωcm is obtained for the film deposited at about 800° C. with NH₃ and DSB flow rates of 5 sccm. Post deposition annealing was shown to further lower the resistivity.

As will be understood by those skilled in the art, the present invention may be embodied in other specific forms without departing from the essential characteristics thereof. For example, the SiC layer may be deposited in any LPVCD chamber or any other suitable CVD chamber and on a variety of substrates, such as silicon, silicon dioxide, silicon carbide, quartz and sapphire substrates. These other embodiments are intended to be included within the scope of the present invention, which is set forth in the following claims.

What is claimed is:

1. A method of depositing silicon carbide on a substrate, comprising:
placing a substrate in a low pressure chemical vapor deposition chamber;
flowing a single source precursor gas containing silicon and carbon into the chamber;
maintaining the chamber at a pressure not less than approximately 5 mTorr; and
maintaining the substrate temperature less than approximately 900° C.

2. The method of claim 1 comprising maintaining the chamber at a pressure not less than approximately 50 mTorr.

3. The method of claim 1 comprising maintaining substrate temperature less than approximately 700° C.

4. The method of claim 1 wherein flowing a single source precursor gas comprises flowing a gas comprising 1,3-disilabutane.

5. The method of claim 1 comprising depositing a polycrystalline silicon carbide layer by maintaining the substrate temperature above approximately 750° C.

6. The method of claim 1 wherein the substrate comprises a micro electromechanical structure.

7. The method of claim 1 wherein the substrate comprises a silicon carbide-coated micro electromechanical structure.

8. A method of coating a micro electromechanical structure with a silicon carbide coating, comprising:
placing a substrate including the micro electro-mechanical structure in a low pressure chemical vapor deposition chamber;
flowing a single source precursor gas containing silicon and carbon into the chamber;
maintaining the chamber at a pressure not less than approximately 5 mTorr; and
maintaining the substrate temperature less than approximately 900° C.

9. The method of claim 8 comprising maintaining the chamber at a pressure not less than approximately 50 mTorr.

10. The method of claim 8 comprising maintaining substrate temperature less than approximately 700° C.

11. The method of claim 8 wherein flowing a single source precursor gas comprises flowing a gas comprising 1,3-disilabutane.

12. The method of claim 8 comprising depositing a polycrystalline silicon carbide layer by maintaining the substrate temperature above approximately 750° C.

13. A method of depositing a nitrogen doped silicon carbide on a substrate, comprising:
placing a substrate in a low pressure chemical vapor deposition chamber;
flowing a single source precursor gas containing silicon and carbon into the chamber;
flowing a gas comprising a nitrogen dopant into the chamber;
maintaining the chamber at a pressure not less than approximately 5 mTorr; and
maintaining the substrate temperature less than approximately 900° C.

14. The method of claim 13 comprising maintaining the chamber at a pressure not less than approximately 50 mTorr.

15. The method of claim 13 comprising maintaining the substrate temperature less than approximately 700° C.

16. The method of claim 13 wherein flowing a gas comprising a nitrogen dopant comprises flowing a gas comprising ammonia.

17. The method of claim 16 wherein said flowing a gas ammonia comprising ammonia comprises flowing ammonia in a mixture with hydrogen gas.

18. The method of claim 13 wherein the resistivity of the doped film decreases as the flow rate of the gas comprising the nitrogen dopant is increased.

19. The method of claim 13 further comprising annealing the deposited nitrogen doped silicon carbide to reduce the resistivity of the deposited nitrogen doped silicon carbide film, such that increasing the annealing temperature will result in reducing the resistivity of the deposited nitrogen doped silicon carbide film.

20. The method of claim 13 comprising depositing a polycrystalline silicon carbide layer by maintaining the substrate temperature above approximately 700° C.

21. A composition of matter, comprising:
a substrate; and
a wear resistance coating disposed on the surface of said substrate, wherein said coating comprises a silicon carbide coating and is formed by:
placing the substrate in a low pressure chemical vapor deposition chamber;
flowing a single source precursor gas containing silicon and carbon into the chamber;
maintaining the chamber at a pressure not less than approximately 5 mTorr; and
maintaining the substrate temperature less than approximately 900° C.

22. The composition of matter of claim 21 wherein said substrate is a substrate selected from the group consisting of silicon, silicon dioxide, silicon carbide, quartz and sapphire.

23. The composition of matter of claim 21 wherein said substrate comprises a micro electromechanical structure.

24. The composition of matter of claim 21 wherein said substrate comprises a silicon carbide-coated micro electromechanical structure.

25. The composition of matter of claim 21 comprising maintaining the chamber at a pressure not less than approximately 50 mTorr.

26. The composition of matter of claim 21 comprising maintaining the substrate temperature less than approximately 700° C.

27. The composition of matter of claim 21 wherein flowing a single source precursor gas comprises flowing a gas comprising 1,3-disilabutane.

28. The composition of matter of claim 21 comprising depositing a polycrystalline silicon carbide layer by maintaining the substrate temperature above approximately 750° C.
